(19) United States
(12) Patent Application Publication
(10) Pub. No.: US 2021/0120782 A1
(43) Pub. Date: Apr. 29, 2021

(54) DOGGIE FECES CATCHER/BAGGER

(71) Applicants: Stephanie Baker, St. Charles, MO (US); Janice McCord, St. Charles, MO (US)

(72) Inventors: Stephanie Baker, St. Charles, MO (US); Janice McCord, St. Charles, MO (US)

(21) Appl. No.: 16/666,391

(22) Filed: Oct. 28, 2019

(51) Int. Cl. A01K 23/00

(52) U.S. Cl. CPC A01K 23/005

(57) ABSTRACT

An illustrated view of an exemplary doggie bagger device for catching dog waste or feces prior to hitting any surface is presented. The doggie bagger device is useful for cleaning and efficiently removing the defecation of a dog from various areas without having a person making contact with the feces. The doggie bagger device is useful for providing an efficient and smell-less removal of dog feces and efficiently discarding of the dog feces.

### FIELD OF THE INVENTION

This invention relates to dog feces. More particularly, it relates to a device for catching dog feces.

### BACKGROUND

Feces are the solid or semisolid remains of food that could not be digested in the small intestine. Bacteria in the large intestine further break down the material. Feces contain a relatively small amount of metabolic waste products such as bacterially altered bilirubin, and the dead epithelial cells from the lining of the gut.

Feces are discharged through the anus or cloaca during defecation. Feces can be used as fertilizer or soil conditioner in agriculture. It can also be burned as fuel or dried and used for construction. Some medicinal uses have been found. In the case of human feces, fecal transplants or fecal bacteriotherapy are in use. Urine and feces together are called excreta.

The distinctive odor of feces is due to bacterial action. Gut flora produces compounds such as indole, skatole, and thiols (sulfur-containing compounds), as well as the inorganic gas hydrogen sulfide. These are the same compounds responsible for the odor of flatulence. Consumption of spicy foods may result in the spices being undigested and adding to the odor.

The perceived bad odor of feces has been hypothesized to be a deterrent for humans, as consuming or touching it may result in sickness or infection. Human perception of the odor may be contrasted by a non-human animal's perception of it; for example, an animal who eats feces may be attracted to its odor.

In light of the foregoing, there is a need for a device to safely, efficiently and cleanly to gather and catch dog feces from locations such as yards, sidewalks and the like.

### BRIEF DESCRIPTION OF THE DRAWINGS

FIG. 1A is an illustrated view of an exemplary doggie bagger device.

FIG. 1B is an illustrated closed view of the doggie bagger device shown in FIG. 1A.

FIG. 1C is an illustrated view of a baggie of the doggie bagger device shown in FIG. 1A.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

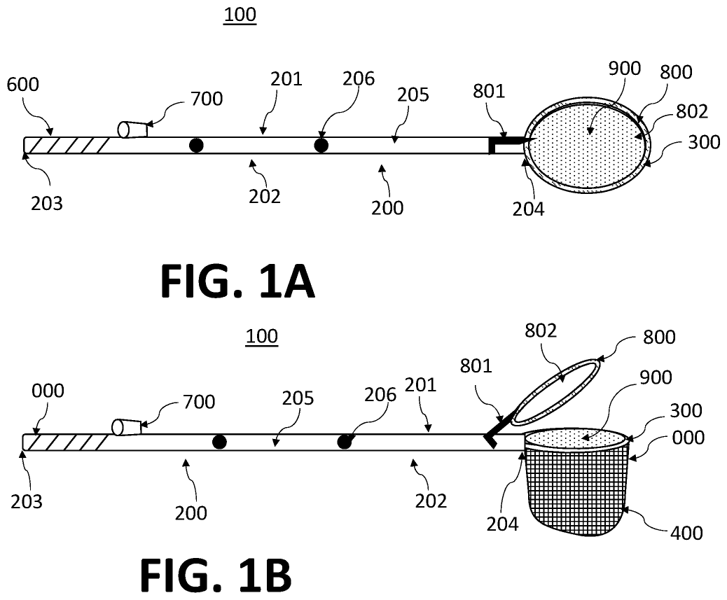

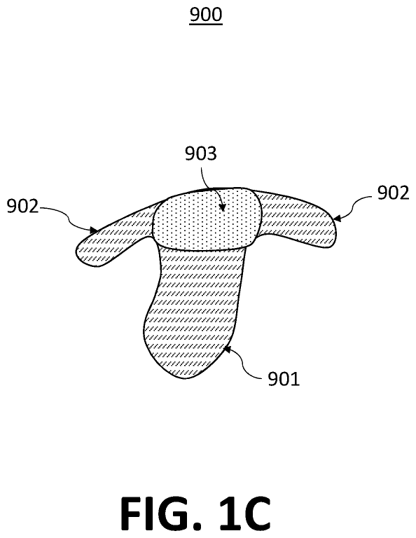

Referring to FIG. 1A and FIG. 1B, an illustrated view of an exemplary doggie bagger device 100 for catching dog waste or feces prior to hitting any surface is presented. The doggie bagger device 100 is useful for cleaning and efficiently removing the defecation of a dog from various areas without having a person making contact with the feces. The doggie bagger device 100 is useful for providing an efficient and smell-less removal of dog feces and efficiently discarding of the dog feces.

The doggie bagger device 100 has a pole 200, a bag frame 300, a bag holder 400, a grip 600, a holder 700 and a clamp 800.

The pole 200 is preferably made of an aluminum material, however other materials are hereby contemplated, including, but not limited to, plastic, poly-vinyl chloride (PVC), etc. The pole 200 is preferably extendable.

The pole 200 has a first side 201, a second side 202, a first end 203, a second end 204, a middle portion 205 and a plurality of release buttons 206. The pole 200 preferably has a retracted length of twelve to eighteen (12-18) inches, however other retracted lengths are hereby contemplated, including, but not limited to, ten (10) inches, twenty (20) inches, etc. The pole 200 preferably has a fully extended length of three to four (3-4) feet, however other fully extended lengths are hereby contemplated, including, but not limited to, two (2) feet, five (5) feet, etc.

The plurality of release buttons 206 are coupled to a middle 205 of the pole 200. The plurality of release buttons 206 are configured to lock the pole in an extended or retracted position. The plurality of release buttons 206 are preferably push pin release buttons. The plurality of release buttons 206 are preferably two (2) in number.

The holder 700 is securely coupled to the first side 201 of the pole 200 substantially near the first end 203 of the pole 200. The holder 700 is configured to hold additional bags 900 to be used with the doggie bagger device 100.

The grip 600 is coupled substantially near the first end 203 of the pole 200. The grip 600 is preferably made of a rubber material. The grip 600 is configured to provide a comfortable grip for a user of the doggie bagger device 100.

The bag frame 300 is coupled to the second end 204 of the pole 200. The bag frame 300 is preferably oval shape, however other shapes are hereby contemplated, including, but not limited to, round square, etc.

The bag holder 400 is coupled to the bag frame 300. The bag holder 400 is preferably a netting material. The bag holder 400 is configured to hold a bag 900. The clamp 800 is configured to be opened and closed by a control bar 801. The control bar 801 is further coupled to significantly near the second end 204 of the pole 200. The control bar 801 is configured to open and close the clamp 800. The clamp 800 is preferably open in a middle 802 of the clamp 800. The clamp 800, when closed, is configured to prevent the bag 900 from be released from the bag holder 400.

FIG. 1B shows the bag 900 coupled to the bag holder 400 when the clamp 800 is in an open condition, such that the bag 900 can be placed into the bag holder 400 or be removed from the bag holder 400.

Referring to FIG. 1C, the bag 900 is shown. The bag 900 has a holding portion 901, an inside 903 and one or more extended straps 902. When the dog feces have been scooped into the inside 903 of the bag 900 using the doggie bag holder 100, the clamp 800 is opened to allow access to the bag 900. The straps 902 of the bag 900 are then tied to prevent spillage of the feces and the bag 900 is removed from the bag holder 400. A bag 900 is removed from the holder 400 and placed into the bag holder 400.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A doggie bagger device for catching dog waste or feces prior to hitting a surface, the device comprising:
a pole, the pole having a first end, a second end, a first side and a middle portion;
a plurality of release buttons, the release button being coupled to the middle portion of the pole;
a holder, the holder coupled to the first side of the pole, wherein the holder being configured to hold at least one bag;
a grip, the grip being coupled to substantially near the first end of the pole;
a frame, the frame being coupled to the second end of the pole, wherein a bag holder being coupled to the frame; and
a clamp, the clamp being coupled to substantially near the second end of the pole by a control bar.

2. The device of claim 1, wherein the pole having a retracted length being twelve to eighteen (12-18) inches.

3. The device of claim 1, wherein the pole having a full extended length being three to four (3-4) feet.

4. The device of claim 1, wherein the pole being extendable.

5. The device of claim 1, wherein the bag holder being made of a netting material.

6. The device of claim 1, wherein the bag further comprising:
a holding portion, the holding portion configured to hold the bag; and
one or more straps, the one or more straps being configured to securely close the bag.

7. The device of claim 1, wherein the release buttons being pin-push release buttons.

8. The device of claim 1, wherein the release buttons being two (2) in number.
